(19) United States
(12) Patent Application Publication
(10) Pub. No.: US 2009/0011730 A1
(43) Pub. Date: Jan. 8, 2009

(54) Methods and Apparatus for Controlling Power in a Polar Modulation Transmitter

(75) Inventors: Paul Cheng-Po Liang, Santa Clara, CA (US); Earl W. McCune, JR., Santa Clara, CA (US)

Correspondence Address: PATENT LAW PROFESSIONALS, P.O. BOX 612407, SAN JOSE, CA, 95161, US

(73) Assignee: Matsushita Electric Industrial Co., Ltd.

(21) Appl. No.: 11/773,612

(22) Filed: Jul. 5, 2007

(51) Int. Cl. H04B 1/04

(52) U.S. Cl. 455/127.2; 455/127.1

(57) ABSTRACT

A power amplifier of a polar transmitter having separate amplitude and phase paths is configured so that its output power is controlled by power control circuitry disposed in both the amplitude and phase paths of the transmitter. Coarse power control is provided by coarse power control circuitry configured in the phase path. Fine power control is performed by digital power control circuitry configured in the amplitude path. The combined coarse power control circuitry in the phase path and digital power control circuitry in the amplitude path allows the output power of the power amplifier to be controlled at the accuracy and resolution required by wireless communications standards such as, for example, the W-CDMA standard.

### FIELD OF THE INVENTION

The present invention relates to power control in communications transmitters.

### BACKGROUND OF THE INVENTION

Wireless communication technologies have undergone tremendous growth over the last decade. The accumulation of large numbers of subscribers and the introduction of high bandwidth applications such as gaming, music downloading and video streaming have placed strains on network capacity. Newer generation wireless communication systems, such as the third generation (3G) Wide-Band Code Division Multiple Access (W-CDMA) wireless interface, strive to improve network capacity by making more efficient use of the radio frequency (RF) spectrum.

Compared to earlier generation systems, W-CDMA uses more bandwidth-efficient modulation schemes that directly improve network capacity. Network capacity is also indirectly increased by controlling power levels between mobile terminals and associated basestations. Each mobile terminal in a basestation cell of a W-CDMA based system is required to transmit at a power level that results in the basestation receiving the same power level from all mobile terminals. To account for different and varying distances between the various mobile terminals and the basestation, the W-CDMA standard requires that the basestation periodically send a Transmit Power Control (TPC) command (1500 times per second) to each of the mobile terminals. The TPC commands direct the transmitters of the mobile terminals to increase or decrease their output power levels in discrete steps (e.g., +/−1 dB, +/−2 dB, +/−3 dB, etc.), so that the appropriate power levels from all mobile terminals are received at the basestation. Controlling power in this manner reduces interference between mobile terminals and, consequently, allows more mobile terminals to share the same carrier. The result is an increase in network capacity and greater overall power efficiency.

The W-CDMA specification also requires the RF transmitter of each mobile terminal to be capable of controlling its output power over a wide dynamic range (80 dB in the W-CDMA specification). This ensures that all mobile terminals, irrespective of their distance from the basestation, have the capability of transmitting at the power needed to result in the basestation receiving the same power level from all mobile terminals.

Wide dynamic range in output power is difficult to achieve in conventional quadrature modulator transmitters. To avoid signal distortion the power amplifier (PA) used in such transmitters must be configured to operate linearly. Unfortunately, linear operation cannot be easily maintained over the wide dynamic range demanded by the W-CDMA standard.

The polar modulation transmitter is an alternative type of transmitter that is capable of controlling output power over a wide dynamic range. Because of this capability, and because it is more power efficient than the conventional quadrature modulator transmitter, the polar modulation transmitter has gained widespread recognition as a transmitter suitable for W-CDMA and other next generation wireless communication systems.

FIG. 1 is a diagram of a typical polar modulation transmitter (or “polar transmitter”) 100. As shown, the polar transmitter 100 comprises a polar signal generation circuit 102, an amplitude control circuit 104, a phase-modulated signal generation circuit 106, a PA 108, and an antenna 110. The polar signal generation circuit 102 operates on an input signal to provide an envelope component signal containing amplitude information of the input signal and a phase component signal containing phase information of the input signal. The envelope component signal is coupled to an input of the amplitude control circuit 104 along an amplitude path, and the phase component signal is coupled to an input of the phase-modulated signal generation circuit 106 along a phase path. The phase-modulated signal generation circuit 106 is configured to receive the phase component signal and generate a constant-amplitude phase-modulated RF drive signal, which is coupled to an RF input of the PA 108 along the phase path. The amplitude control circuit 104 is configured to receive the envelope component signal along the amplitude path and provide an amplitude modulated power supply voltage, which is coupled to a power supply port of the PA 108. The PA 108 amplifies the constant-amplitude phase-modulated RF drive signal in the phase path according to the amplitude modulated power supply voltage, thereby providing a modulated RF output signal which is radiated by the antenna 108 to a remote basestation.

The polar transmitter 100 achieves wide dynamic range in output power by configuring the PA 108 to operate in compressed mode during times when a high transmission power is required, and configuring the PA 108 to operate in uncompressed mode during times when only a low transmission power is required. When configured in compressed mode the output power of the transmitter 100 is controlled by the amplitude modulated power supply voltage applied to the collector (or drain) node of the PA 108, while the power of the constant-amplitude phase-modulated RF drive signal is kept constant. When configured in uncompressed mode, the output power of the PA 108 is controlled by varying the power of the phase-modulated RF drive signal, while the collector (or drain) node of the PA 108 is also modulated with the envelope signal.

In addition to requiring a wide dynamic range in output power, the W-CDMA standard requires the transmitter of a mobile terminal to comply with certain specified power control tolerances. As shown in the table in FIG. 2, compliance with these power control tolerances must be made and maintained after the transmitter changes its output power in response to a Transmit Power Control (TPC) command. So, for example, if a transmitter of a mobile terminal is operating at 0 dBm, and a TPC command of “1” is received, the transmitter of the mobile terminal must be capable of adjusting its output power to within a range of +0.5 dBm and 1.5 dBm for a nominal 1 dB step up in power.

The level of power control accuracy needed for W-CDMA applications is not easily realized using the polar transmitter 100 in FIG. 1. The difficulty arises from the fact that analog circuitry is used to perform and control the transmitter's output power. An analog signal provided by an analog portion of the amplitude control circuit 104 is used to control the output power of the PA 108, when the PA 108 is configured to operate in compressed mode. Some degree of power control can also be achieved for uncompressed mode operation by inserting a variable gain amplifier 112 in the phase path of the transmitter, as shown in FIG. 3. Unfortunately, a variable gain amplifier that is capable of controlling output power at the accuracies and resolution necessary to satisfy the W-CDMA power control tolerance specifications is difficult to design, especially when the design requires operation over a very wide dynamic range.

In addition to the foregoing problems, analog power control solutions are sensitive to temperature, difficult to consistently manufacture, consume large portions of integrated circuit area, and use significant amounts of power. It would be desirable, therefore, to have methods and apparatus for controlling output power in a polar transmitter, which are capable of controlling output power at the precision necessary to satisfy the power control specifications of the W-CDMA standard, and similar specifications of other standards.

### SUMMARY OF THE INVENTION

Methods and apparatus for controlling output power in radio frequency (RF) transmitters are disclosed. An exemplary RF transmitter comprises a polar transmitter having separate amplitude and phase paths. A power amplifier of the transmitter is adapted so that its output power can be controlled by power control circuitry disposed in both the amplitude and phase paths of the transmitter. Coarse power control is provided by coarse power control circuitry (e.g., by a step attenuator or a variable gain amplifier) configured in the phase path. Fine power control is performed by digital power control circuitry configured in the amplitude path. Complementing the coarse power control in the phase path with the fine digital power control in the amplitude path allows the output power of the power amplifier to be controlled at the accuracy and resolution needed to satisfy strict power control standards such as, for example, those specified by the W-CDMA standard.

Further aspects of the invention are described and claimed below, and a further understanding of the nature and advantages of the invention may be realized by reference to the remaining portions of the specification and the attached drawings, in which like reference numbers are used to indicate identical or functionally similar elements.

### BRIEF DESCRIPTION OF THE DRAWINGS

FIG. 1 is a diagram of a typical polar modulation transmitter;

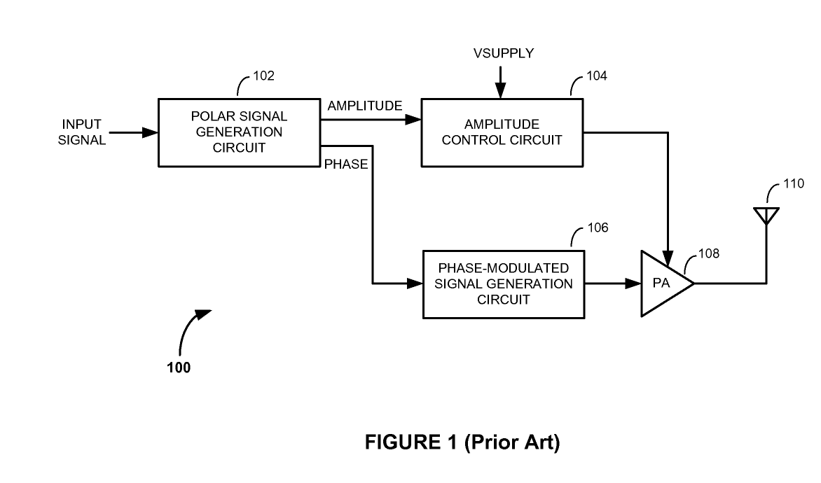

FIG. 2 is a table showing transmitter power control tolerances for various power level step sizes, as specified by the W-CDMA standard;

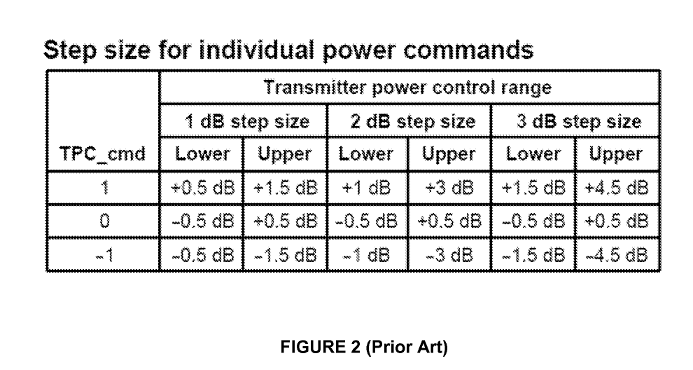

FIG. 3 is a diagram of a typical polar modulation transmitter that employs a variable gain amplifier to provide a limited degree of power control;

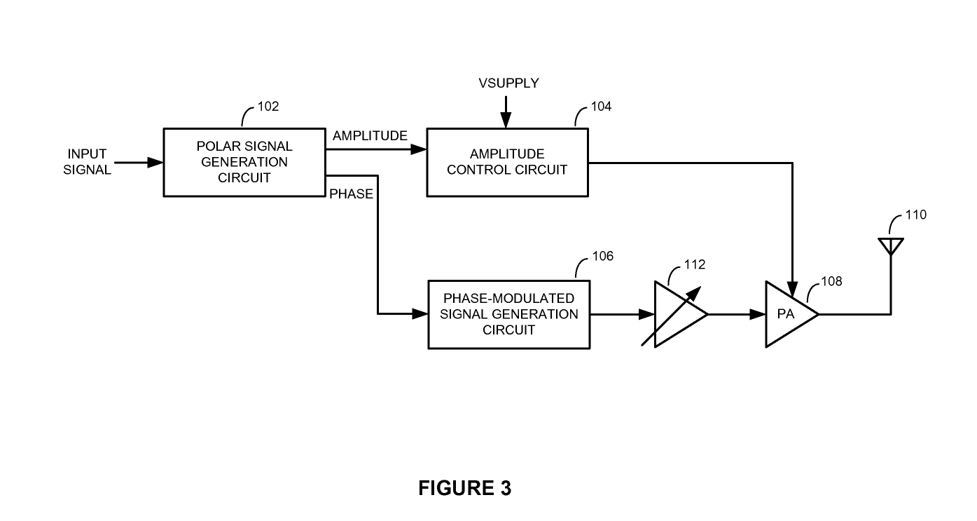

FIG. 4 is a diagram of a polar modulation transmitter having digital power control capabilities, according to an embodiment of the present invention; and

FIG. 5 is a diagram of a polar modulation transmitter having digital power control capabilities and a power measurement feedback loop, according to an embodiment of the present invention.

### DETAILED DESCRIPTION

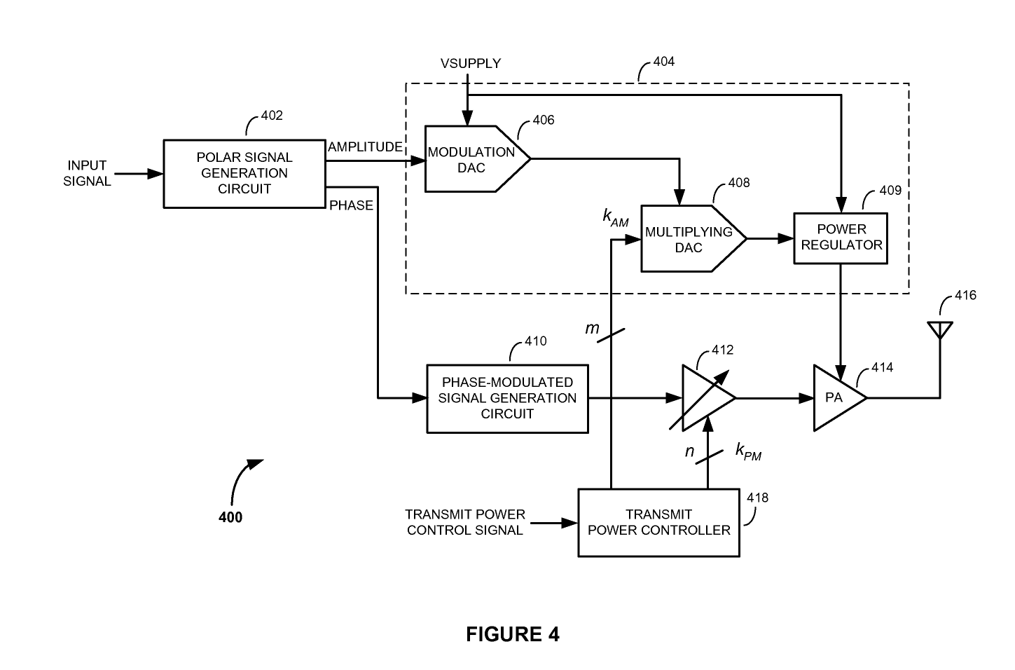

Referring to FIG. 4, there is shown diagram of a polar modulation transmitter 400, according to an embodiment of the present invention. The polar modulation transmitter 400 comprises a polar signal generation circuit 402; an amplitude path having an amplitude control circuit 404 including a modulation digital-to-analog converter (DAC) 406, a multiplying DAC 408 and a power regulator 409; a phase path having a phase-modulated signal generation circuit 410 and a variable gain amplifier (or in an alternative embodiment, a step attenuator) 412; a power amplifier (PA) 414; an antenna 416; and a transmit power controller 418.

The polar signal generation circuit 402 operates on an input signal to provide an envelope signal containing amplitude information of the input signal and a phase component signal containing phase information of the input signal. The envelope signal is coupled to an input of the modulation DAC 406 of the amplitude control circuit 404, in an amplitude path of the transmitter 400. The modulation DAC 406 modulates a power supply voltage, VSUPPLY, according to the shape of the envelope signal and couples the resulting amplitude modulated power supply signal a(t) to a reference voltage input of the multiplying DAC 408. The output of the multiplying DAC 408 is coupled to the power regulator 409, the output of which is coupled to the power control input of the power amplifier (PA) 414. Based on the product of the amplitude modulated power supply signal a(t) and the value of an m-bit (m is a positive integer) digital power control factor k_{AM} received from the transmit power controller 418, the multiplying DAC 408 generates an analog power control signal, which is coupled through the power regulator 409 to the power control input of the PA 414.

In the phase path of the transmitter 400, the phase component signal from the polar signal generation circuit 402 is coupled to an input of the phase-modulated signal generation circuit 410. The phase-modulated signal generation circuit 410 upconverts the phase component signal to radio frequency (RF) to provide a signal cos(ω_{c}t+φ(t)), where ω_{c} represents the radian frequency of the RF carrier and φ(t) represents the phase modulation of the upconverted signal. The variable gain amplifier (or step attenuator) 412 scales the magnitude of the upconverted phase component signal cos(ω_{c}t+φ(t)), based on the value of an n-bit (n is a positive integer) digital gain control factor k_{PM} received from the transmit power controller 418, to provide a scaled upconverted phase component signal k_{PM}×cos(ω_{c}t+φ(t)).

The scaled upconverted phase component signal k_{PM}×cos(ω_{c}t+φ(t)) is coupled to an RF input of the PA 414, which is operable to amplify the signal according to the analog power control signal k_{AM}×a(t) applied to the power control input of the PA 414. The amplified and upconverted signal a(t)×k_{AM}×k_{PM}×cos(ω_{c}t+φ(t)) is coupled to the antenna 416, which radiates the signal to a remote receiver (e.g., a cellular basestation receiver). In accordance with an embodiment of the invention, this is realized in a manner similar to that taught in U.S. Pat. No. 7,010,276, which is incorporated into this disclosure by reference.

Power control in the polar modulation transmitter 400 is directed by the transmit power controller 418. Unlike prior art approaches which provide power control in only one of either the amplitude and phase paths, depending on whether the transmitter PA is configured to operate in uncompressed or compressed mode, power control in the polar modulation transmitter 400 of the present invention is provided in both the amplitude and phase paths at the same time. According to an embodiment of the invention, the n-bit digital gain control signal is used to coarsely control (e.g., in 1 dB steps) the output power level of the transmitter 400, and the m-bit digital power control signal is used to finely control (e.g., at a 0.25 dB resolution) the output power level of the transmitter 400. More specifically, the value of the n-bit digital gain control factor k_{PM} is used to set the amplification (or attenuation) of the variable gain amplifier (or step attenuator) 412 in the phase path of the transmitter 400 and, at the same time, the value of the m-bit digital power control factor k_{AM} is used by the multiplying DAC 408 to adjust the amplitude of analog power control signal applied to the power setting input of the PA 414 in the amplitude path of the transmitter 400. The fine power control provided by the m-bit digital power control signal in the amplitude path of the transmitter 400 causes the PA 414 to interpolate between the coarse power levels set by the n-bit digital gain control signal in the phase path of the transmitter 400. The interpolative effect results in greater resolution and more accurate power control than is obtainable by controlling power in the phase path alone.

According to one aspect of the invention, the values of m and n are selected so that output power can be controlled at the accuracy and resolution needed to satisfy the power control tolerances specified by the W-CDMA standard, as well as other standards that have stringent power control requirements. The transmit power controller 418 determines the actual values needed for the control factors k_{AM} and k_{PM} by acting on the value of a Transmit Power Control Signal (TPCS). The TPCS is determined by the baseband as an absolute power control setting, based on the history of TPC and related system commands transmitted to the associated mobile device by the communications system being used (e.g., W-CDMA).

Providing power control in both the amplitude and phase paths of the polar modulation transmitter 400 is particularly beneficial during times when the PA 414 of the transmitter 400 is configured to operate in uncompressed mode, which is a mode in which power control can be particularly difficult. Providing digital power control in the amplitude path of the transmitter 400 during times when the PA 414 is configured to operate in uncompressed mode avoids limitations that analog devices have in controlling power in the phase path of the transmitter 400, and simplifies the design requirements of the variable gain amplifier (or step attenuator) 412, since it must only operate to coarsely control output power. Nevertheless, while the above embodiments have been described in the context of providing power control in both the amplitude and phase paths of the transmitter simultaneously, those of ordinary skill in the art will readily appreciate and understand that if applications dictate or allow, power control in one of the phase and amplitude paths may be applied independently while power control in the other path is either maintained at some constant value or is not provided at all.

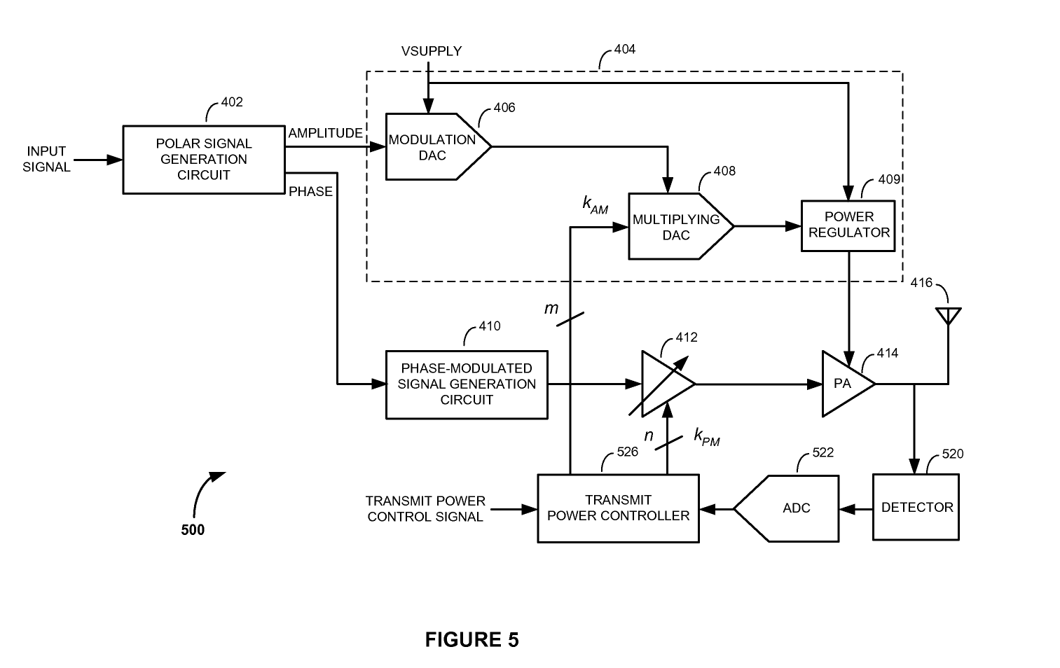

FIG. 5 is a diagram of a polar modulation transmitter 500, according to another embodiment of the present invention. This embodiment is similar to that shown in FIG. 4, except that it also includes a power measurement feedback loop. The power measurement feedback loop includes a power level detector 520 and an analog-to-digital converter (ADC) 522. The power detector 520 measures the output power level of the transmitter 500 at the output of the PA 412. The ADC 522 converts the power measurement to a digital signal, which is coupled to a digital input of the transmit power controller 524. The transmit power controller 524 is then operable to use the digitized version of the measured output power to adjust the m-bit digital power control and/or the n-bit digital gain control factors k_{AM} and k_{PM}, so that the desired output power level of the transmitter 500 is provided as commanded by the TPCS.

While the above is a complete description of the preferred embodiments of the invention sufficiently detailed to enable those skilled in the art to build and implement the system, it should be understood that various changes, substitutions, and alterations may be made without departing from the spirit and scope of the invention as defined by the appended claims.

What is claimed is:

1. A method of controlling output power of a power amplifier in a polar transmitter, comprising:
using coarse power control circuitry configured in a phase path of a polar transmitter, coarsely adjusting an output power level setting of a power amplifier from a first coarse output power level setting to a second coarse output power level setting; and
using digital power control circuitry configured in an amplitude path of the polar transmitter, finely controlling the output power of the power amplifier between the first and second coarse output power settings.

2. The method of claim 1 wherein the digital power control circuitry configured in the amplitude path of the polar transmitter comprises a multiplying digital-to-analog converter (DAC).

3. The method of claim 1 wherein the coarse power control circuitry configured in the phase path of the polar transmitter comprises a step attenuator.

4. The method of claim 1 wherein the coarse power control circuitry configured in the phase path of the polar transmitter comprises a variable gain amplifier.

5. The method of claim 1 wherein coarsely adjusting the output power of the power amplifier from the first coarse output power level setting to the second coarse output power level setting is performed in response to a transmit power control command received by the polar transmitter from a cellular basestation.

6. The method of claim 1, further comprising:
detecting the output power of said power amplifier; and
using the detected output power to finely control the output power level of the power amplifier.

7. A polar transmitter, comprising:
a radio frequency (RF) power amplifier having an RF input and a power supply input;
a phase path having circuitry configured to receive a phase-modulating signal and provide an RF constant-amplitude phase-modulated signal to the RF input of the power amplifier; and
an amplitude path having circuitry configured to receive an envelope signal and provide a modulated power supply signal to the power supply input of said power amplifier,
wherein the circuitry in said amplitude path includes digital power control circuitry operable to control an output power level of the power amplifier.

8. The polar transmitter of claim 7 wherein the circuitry in said phase path includes coarse power control circuitry that controls the amplitude of the RF constant-amplitude phase-modulated signal applied to the RF input of the power amplifier.

9. The polar transmitter of claim 8 wherein said digital power control circuitry is configured to interpolate between coarse output power level settings provided by said coarse power control circuitry.

10. The polar transmitter of claim 7 wherein said digital power control circuitry comprises a multiplying digital-to-analog converter.

11. The polar transmitter of claim 7, further comprising a transmit power controller operable to provide a digital power control factor for use by said digital power control circuitry to digitally control the output power level of the power amplifier.

12. The polar transmitter of claim 11 wherein a value of said digital power control factor is determined based on a transmit power control signal applied to the transmit power controller.

13. The polar transmitter of claim 12, further comprising a detector coupled to the output of the power amplifier operable to detect an output power level of the power amplifier, wherein the detected output power level and said transmit power control signal are used to determine a value of said digital power control factor.

14. A method of controlling the output power level of a power amplifier, comprising:
receiving a radio frequency (RF) signal at an RF input of a power amplifier;
modulating a power supply signal with an amplitude varying signal to produce a modulated power supply signal;
digitally controlling the amplitude of the modulated power supply signal to produce a modified-amplitude modulated power supply signal;
applying the modified-amplitude modulated power supply signal to a power supply input of said power amplifier; and
amplifying said RF signal according to the modified-amplitude modulated power supply signal applied to the power supply input of said power amplifier.

15. The method of claim 14, further comprising amplifying or attenuating the RF signal applied to the RF input of the power amplifier.

16. The method of claim 15 wherein amplifying or attenuating the RF signal is performed to coarsely control the output power level of said power amplifier.

17. The method of claim 16 wherein digitally controlling the amplitude of the modulated power supply signal is performed to finely control the output power level of the power amplifier between first and second coarse power levels controlled by the amplified or attenuated RF signal applied to the RF input of the power amplifier.

18. The method of claim 14, further comprising:
detecting an output power level of the power amplifier; and
using the detected output power level to determine the value of a digital power control factor used in digitally controlling the amplitude of the modulated power supply signal.

19. A radio frequency transmitter, comprising:
means for coarsely adjusting an output power level of a power amplifier of a polar transmitter from a first coarse output power level setting to a second output power level setting;
means for interpolating between said first and second coarse output power level settings; and
means for setting the power amplifier to operate at a power level determined by said means for interpolating.

20. The radio frequency transmitter of claim 19 wherein said means for coarsely adjusting an output power level of a power amplifier is configured within a phase path of a polar transmitter, and said means for interpolating between said first and second coarse power level settings is configured within an amplitude path of the polar transmitter.

21. The radio frequency transmitter of claim 19 wherein said means for coarsely adjusting the output power level of the power amplifier is performed in response to a transmit power control command received from a cellular basestation.

22. An apparatus, comprising:
a power amplifier;
a transmit power controller configured to provide a power control factor and a gain control factor;
an amplitude control circuit configured to provide a power control signal, based on the power control factor and a signal containing amplitude information, to a power control input of the power amplifier; and
a variable gain amplifier configured to provide a scaled upconverted phase component signal, based on an upconverted phase component signal and the gain control factor, to an RF input of the power amplifier.

23. The apparatus of claim 22 wherein a value of the power control factor supplied to the amplitude control circuit and a value of the gain control factor supplied to the variable gain amplifier are determined based on a transmit power control signal.
